(19) United States
(12) Patent Application Publication
(10) Pub. No.: US 2026/0080404 A1
(43) Pub. Date: Mar. 19, 2026

(54) MOBILE TRANSACTION SYSTEM FOR ENHANCING USER EXPERIENCE

(71) Applicant: eClip LLC, San Francisco, CA (US)

(72) Inventors: Yajia ZHANG, Sunnyvale, CA (US); Jingru LUO, Sunnyvale, CA (US)

(21) Appl. No.: 18/887,961

(22) Filed: Sep. 17, 2024

(51) Int. Cl. G06Q 20/40

(52) U.S. Cl. CPC G06Q 20/401

(57) ABSTRACT

A method and system for processing transaction data are described herein. The method includes receiving, at the server from a client device, a transaction code obtained by the client device; authenticating and verifying the user based on the transaction code in view of user information; transmitting, to the client device over the network, verification information of the user associated with the transaction code, the verification information including whether the user is a valid user of a mobile transaction system and whether the user is a member of a user group associated with a client; receiving, from the client device over the network, an electronic document in response to determining that the user is a valid user and the user is the member of the user group based on the verification information; and transmitting, to the user device over the network, the electronic document.

### FIELD

Embodiments of the present disclosure relate to the field of systems for software services; more particularly, embodiments of the present disclosure relate to a mobile transaction system.

### BACKGROUND

Software services, such as transaction systems to facilitate transactions amongst devices, play a critical role in daily life in modern society. A mobile transaction system provides convenience to a user. The mobile transaction system may include a server computer system which processes a transaction between a user device and a client device. For the transaction, transaction information is provided by the user device to the client device in satisfaction of the transaction.

Existing mobile transaction systems simply replace an existing transaction handling application with a corresponding mobile application. Beyond that, there is no further benefit for users (e.g., individuals that are involved in transactions) or clients (e.g., stores that process the transactions) for adopting mobile transaction methods. Therefore, the progress of users shifting from legacy transaction system to mobile transaction systems is slow. It is difficult for the users to have an enhancing experience by using the existing mobile systems.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram of an example of a mobile transaction system according to one embodiment.

FIG. 2 is a block diagram illustrating an example of a user verification procedure of a mobile transaction system according to one embodiment.

FIG. 3 is a block diagram illustrating an example of an electronic document generation procedure of a mobile transaction system according to one embodiment.

FIG. 4 is a flow diagram of an example of a transaction procedure of a mobile transaction system from a user's perspective according to one embodiment.

FIG. 5 is a flow diagram of an example of a transaction procedure of a mobile transaction system from a client's perspective according to one embodiment.

FIG. 6 is a flow diagram of an example of a transaction procedure of a mobile transaction system from a server's perspective according to one embodiment.

FIG. 7 is a flow diagram of an example of processing a transaction by a mobile transaction system according to one embodiment.

FIG. 8 is a flow diagram of an example of a server of a mobile transaction system according to one embodiment.

FIG. 9 is a flowchart of a method of processing transaction data according to one embodiment.

FIG. 10 is a block diagram of an example of a computer system that may be used to support the systems and operations discussed herein according to one embodiment.

### DETAILED DESCRIPTION

Various embodiments and aspects of the disclosure will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described to provide a concise discussion of embodiments of the present disclosure.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

Existing mobile transaction methods simply replace existing methods with a mobile method. Beyond that, there is no further benefit for users or clients (, e.g., stores) for adopting mobile transaction methods. Due to the lack of incentives, the progress of users shifting to mobile transaction is slow.

Aspects of the present disclosure address the above-noted and other deficiencies by a mobile transaction system with multiple functionalities which provides asynchronized transaction processing, electronic document and product promotion management. The mobile transaction system will provide convenience and benefits to both a user and a client (e.g., a store). Besides the functionality of processing the transaction, the user has the benefit to of combined verification of transaction and a user group (e.g., store membership) in one operation. In addition, the user may be eligible for an expedited process for the transaction, e.g., an expedited checkout (checkout without waiting for the transaction confirmation and receipt printing). Moreover, the user may perform batch transactions for recent in-person shopping at their time of convenience and organizing receipts. Further, the user may receive and apply a promotion code (e.g., a coupon) from a store. The client (e.g., store) may have the benefits of providing faster user checkout time and better transaction experience. The client (e.g., store) may further reduce costs for printing receipts and related equipment. Further, the client (e.g., store) may perform targeted promotion, thus increasing coupon usage rate, and promoting more transactions. By using the mobile transaction system, the user and the client(e.g., store may have an enhancing experience based on the improvement of technologies.

According to some embodiments, a computer-implemented method of processing transaction data is provided. The method includes:
receiving, at a server from a client device over a network, a transaction code obtained by the client device by scanning the transaction code displayed at a user device of a user using a scanner of the client device, the transaction code uniquely identifying a transaction between the client device and the user device occurred at a point in time;
authenticating and verifying the user based on the transaction code in view of user information of the user stored in a database associated with the server, and generating verification information of the user;
transmitting, to the client device over the network, the verification information of the user associated with the transaction code, the verification information including whether the user is a valid user of a mobile transaction system and whether the user is a member of a user group associated with a client;
receiving, from the client device over the network, an electronic document in response to determining that the user is a valid user and the user is the member of the user group based on the verification information, wherein the electronic document includes information describing one or more activities of the transaction; and
transmitting, to the user device over the network, the electronic document to allow the user to verify the one or more activities with the client device.

According to some embodiments, a mobile transaction system is provided. The mobile transaction system includes a processor; and a memory coupled to the processor to store instructions, which when executed by the processor, cause the processor to perform:
receiving, from a client device over a network, a transaction code obtained by the client device by scanning the transaction code displayed at a user device of a user using a scanner of the client device, the transaction code uniquely identifying a transaction between the client device and the user device occurred at a point in time;
authenticating and verifying the user based on the transaction code in view of user information of the user stored in a database associated with the server, and generating verification information of the user;
transmitting, to the client device over the network, the verification information of the user associated with the transaction code, the verification information including whether the user is a valid user of a mobile transaction system and whether the user is a member of a user group associated with a client;
receiving, from the client device over the network, an electronic document in response to determining that the user is a valid user and the user is the member of the user group based on the verification information, wherein the electronic document includes information describing one or more activities of the transaction; and
transmitting, to the user device over the network, the electronic document to allow the user to verify the one or more activities with the client device.

According to some embodiments, a non-transitory machine-readable medium having instructions stored therein, which when executed by a processor, cause the processor to perform:
receiving, from a client device over a network, a transaction code obtained by the client device by scanning the transaction code displayed at a user device of a user using a scanner of the client device, the transaction code uniquely identifying a transaction between the client device and the user device occurred at a point in time;
authenticating and verifying the user based on the transaction code in view of user information of the user stored in a database associated with the server, and generating verification information of the user;
transmitting, to the client device over the network, the verification information of the user associated with the transaction code, the verification information including whether the user is a valid user of a mobile transaction system and whether the user is a member of a user group associated with a client;
receiving, from the client device over the network, an electronic document in response to determining that the user is a valid user and the user is the member of the user group based on the verification information, wherein the electronic document includes information describing one or more activities of the transaction; and
transmitting, to the user device over the network, the electronic document to allow the user to verify the one or more activities with the client device.

By using the mobile transaction system, the user and the client (e.g., store) may have an enhancing experience. The user has the benefit to of combined verification of transaction and a user group in one operation. In addition, the user may be eligible for an expedited process for the transaction. The user may perform batch transactions, receive and apply a promotion code from a client (e.g., a store). The mobile transaction system provides multiple functionalities to the user, including combined verification of transaction and memberships of multiple clients (e.g., stores), enabling the expedited process for the transaction, performing batch transactions, and intelligently generating, organizing, and applying promotions from multiple clients (e.g., stores) based on technologies. Therefore, the technologies in processing the transaction are improved, and the related computing resources are reduced.

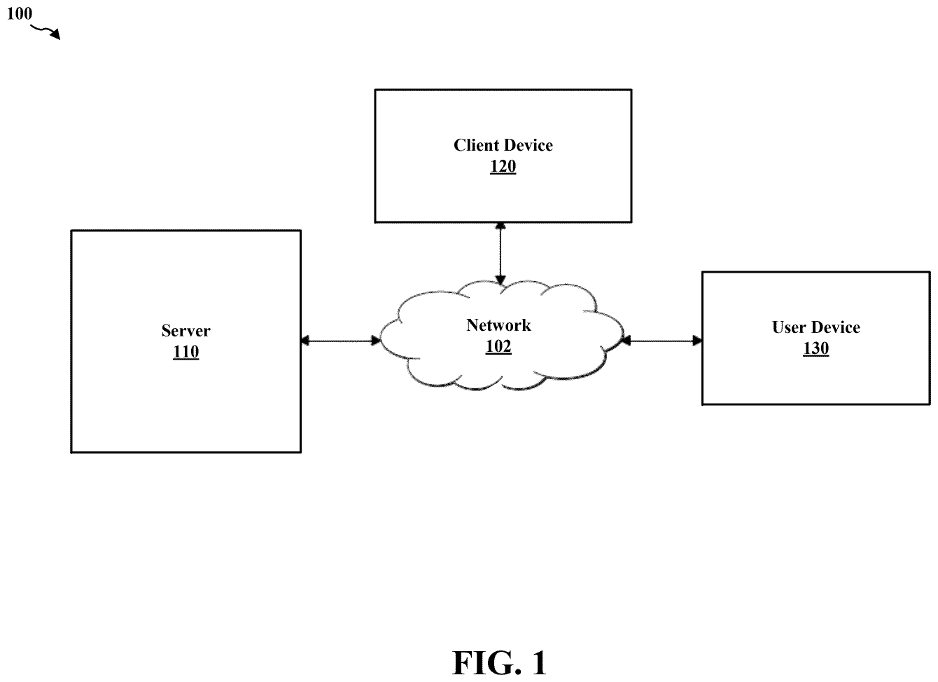

FIG. 1 is a block diagram of an example of a mobile transaction system 100 according to one embodiment. In one embodiment, the system 100 includes a server 110, a client device of a store 120, and a user device 130. In one embodiment, the client device 120 and the user device 130 may be mobile computing devices, such as a smartphone, tablet computer, smartwatch, etc. The server 110 may also be one or more computing devices, such as one or more server computer systems, desktop computer systems, etc.

The server 110, the client device 120, and the user device 130 may be coupled to a network 102 and communicate with one another using any of the standard protocols for the exchange of information, including secure communication protocols. In one embodiment, one or more of the server 110, the client device 120, and the user device 130 may run on one Local Area Network (LAN) and may be incorporated into the same physical or logical system, or different physical or logical systems. Alternatively, the server 110, the client device 120, and the user device 130 may reside on different LANs, wide area networks, cellular telephone networks, etc. that may be coupled together via the Internet but separated by firewalls, routers, and/or other network devices. In one embodiment, the server 110 may be a single server, or include a set of different servers, coupled to other devices via a public network (e.g., the Internet) or a private network (e.g., LAN). It should be noted that various other network configurations can be used including, for example, hosted configurations, distributed configurations, centralized configurations, etc.

In one embodiment, the server 110 provides software service, e.g., transaction processing services to one or more of client device 120, and/or user device 130, such as offering considerations of an electronic documents (e.g., exchanging values), running financial transactions, managing a client and/or a user accounts, managing memberships of the user associated with multiple clients (e.g., stores), managing promotions of the user associated with multiple clients (e.g., stores), as well as other services associated with the mobile transaction system.

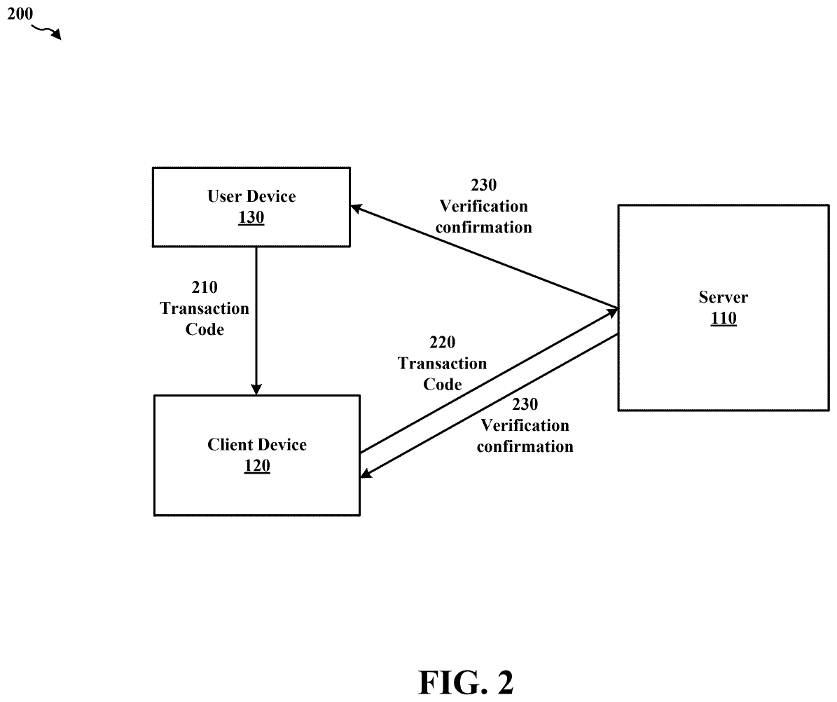

FIG. 2 is a block diagram illustrating an example of a user verification procedure 200 of a mobile transaction system according to one embodiment. Referring to FIG. 2, a user may bring the items to be purchased to a checkout counter. The user may open the application of the mobile transaction system (e.g., eClip app) on a user device 130 (e.g., a smartphone) and initiate a transaction. The user device 130 may create a transaction code (e.g., a payment code) associate with the transaction. The transaction code uniquely identifies the transaction between the client device 120 and the user device 130 occurred at a point in time. The client device 120 may obtain 210 the transaction code by scanning the transaction code displayed at the user device 130 using a scanner of the client device. Both the user device 130 and the client device 120 may communicate with the server 110 of the mobile transaction system.

The server 110 receives 220 the transaction code from the client device 210 over a network. The server 110 authenticates and verifies the user based on the transaction code in view of user information of the user stored in a database associated with the server 110. The server 110 generates verification information of the user. The server 110 transmits 230, to the client device 120 over the network, the verification information of the user associated with the transaction code. The verification information includes whether the user is a valid user of the mobile transaction system and whether the user is a member of a user group associated with the client (e.g., store membership group). The server 110 also transmits 230, to the user device 130 over the network, the verification information of the user associated with the transaction code.

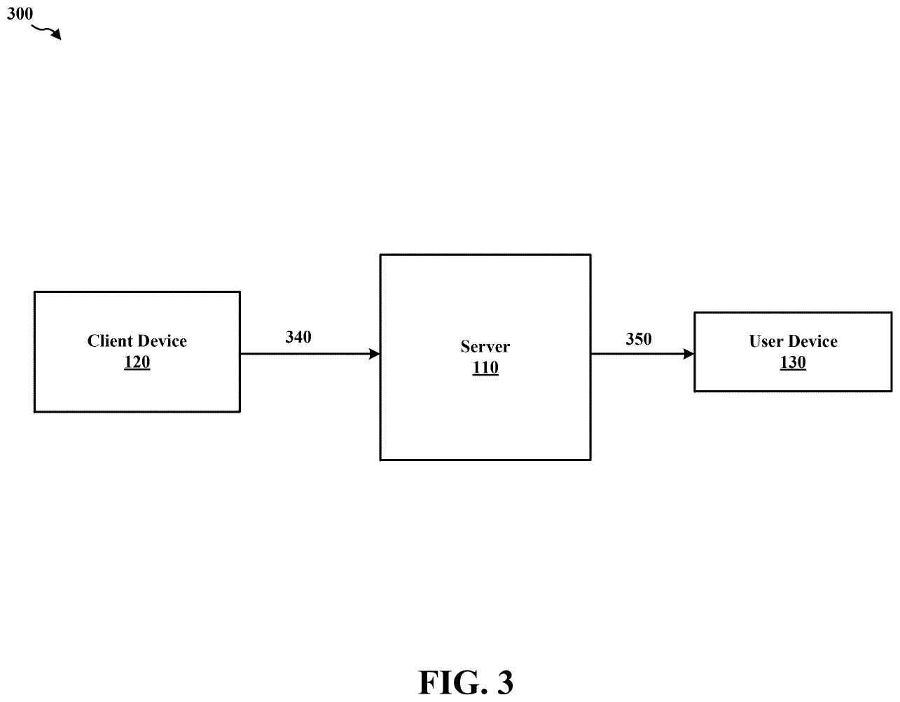

FIG. 3 is a block diagram illustrating an example of an electronic document generation and transmission procedure 300 of the mobile transaction system according to one embodiment. Referring to FIG. 3, in response to determining that the user is a valid user and the user is a member of the user group based on the verification information, the client device 120 may generate an electronic document (e.g., an electronic bill). The client device 120 transmits 340 the electronic document to the server 110. The electronic document includes information describing one or more activities of the transaction (the electron bill/invoice includes one or more items to be purchased). The server 110 transmits 350 the electronic document to the user device 130 over the network to allow the user to verify the one or more activities with the client device 120. The user device receives 350 the electronic bill. The user may offer a consideration from a financial account of the user (e.g., pays for the bill) through the application of the mobile transaction system (e.g., eClip app). The user may receive the electronic receipt after the payment is finished.

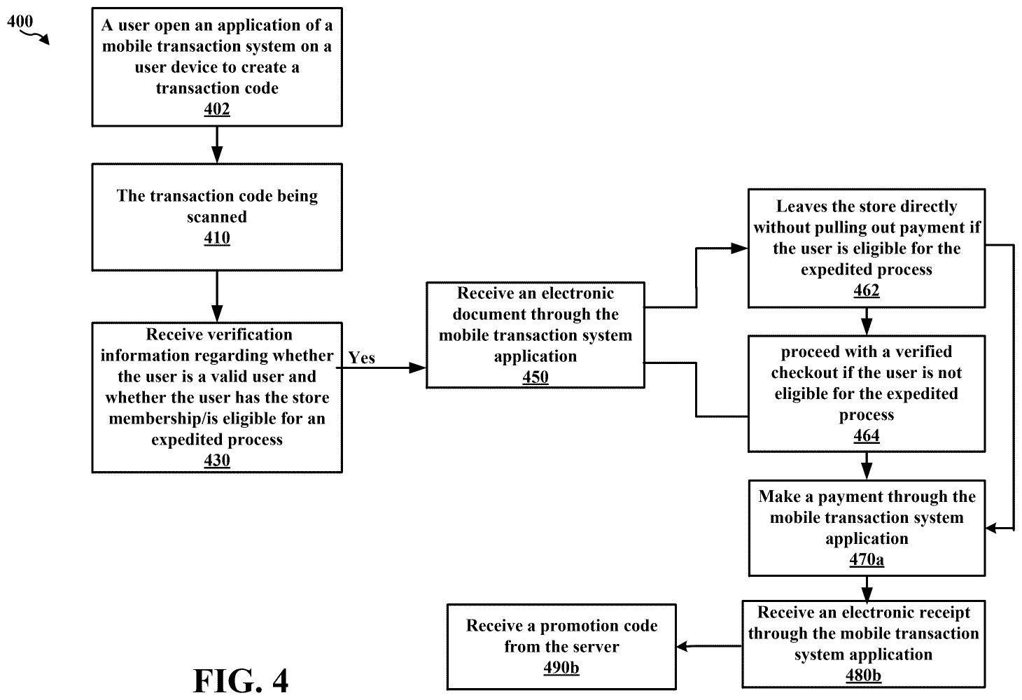

FIG. 4 is a flow diagram 400 of an example of a transaction procedure of a mobile transaction system from a user's perspective according to one embodiment. Referring to FIG. 4, at block 402, the user may open the application of the mobile transaction system on a user device 130 to create a transaction code (e.g., a payment code) associate with the transaction. The transaction code uniquely identifies the transaction between the client device 120 and the user device 130 occurred at a point in time. The transaction code is created per transaction, with short live time, e.g., 10 seconds, 30 second, 1 minute, 2 minutes, 5 minutes, for security purpose. The transaction code does not require internet connection to the server of the mobile transaction system. At any time of the shopping items scanning process, the user may unlock the mobile transaction system application (APP) to create the transaction code.

At block 410, the client device 120 may obtain the transaction code by scanning the transaction code displayed on the user device 130 using a scanner of the client device. The transaction code may be scanned by a store cashier.

At block 430, the user may receive verification information regarding whether the user is a valid user and whether the user is a member of a user group associated with the client (e.g., store membership group). In some examples, the user may receive verification information regarding whether the user is eligible for an expedited process for the transaction (e.g., an expedited checkout). During the expedited process, the user leaves the store without offering a consideration (e.g., payment) associated with the electronic document. Whether the user is eligible for the expedited process may be based on a transaction history of the user and the one or more activities of the electronic document. The transaction history may be maintained at the server and stored in the database. As an example, whether the user is eligible for the expedited process is based on an amount of incomplete transactions of the user or an amount of unfulfilled consideration of the user is less than a first predetermined threshold and an amount of the one or more activities listed in the electronic document is less than a second predetermined threshold. Qualifications for the expedited checkout may include both (1) the user has less than N (e.g., 1, 2, 3, 5, 10, or any numbers therebetween) unpaid bills or the amount of total unpaid bills is less than X (e.g., $10, $50, $100, $200, $500, or any numbers therebetween), and (2) the amount of the transaction is less than Y (e.g., $10, $50, $100, $200, $500, or any numbers therebetween). The expedited checkout may create a time gap between “provided services/goods” and “paid in full”. Expedited checkout may possibly incur unpaid bills to the client (e.g., store) due to a failure to process the user's default payment method.

At block 450, the user may receive an electronic document (e.g., an electronic bill) for the current purchase through the APP immediately after all shopping items are scanned. The electronic document includes information describing one or more activities of the transaction (e.g., one or more shopping items). The server 110 transmits 350 the electronic document to the user device 130 over the network to allow the user to verify the one or more activities with the client device 120.

At block 462, after items are scanned, if the user meets the requirements for the expedited checkout, the user may leave the store directly without pulling out the payment methods, or waiting for the payment to be processed. At a later time within a predefined time period, the user may open the APP and review the electronic document (e.g., bill). The predefined time period may be 1, 2, 3, 5, 10, 20, or 30 days. The user may select a payment credit card, and apply available promotions and store membership information, to offer a consideration (e.g., make a payment) for the electronic document (e.g., bill). The user may make payments for each of multiple expedited checkouts at one time. If the user doesn't offer the consideration (e.g., make the payment) within a certain amount of time after the purchases (e.g., after 7 days), the unpaid bills may be paid automatically using the default payment method stored in the APP or the user may be notified.

At block 464, after items are scanned, if the user does not meet the requirements for the expedited checkout or the user chooses not to use the expedited checkout, the user may proceed with a verified checkout (e.g., the user may pay for the bill immediately at the checkout counter after the bill is received through the APP, the client (e.g., store) receives payment information from the server of the mobile transaction system, and proceeds with the payment transaction). The user might be eligible for an authorized payment (e.g., connecting to Affirm) through the verification checkout for large purchases.

At block 470a, the user device may offer a consideration. e.g., make a payment through the mobile transaction system application. For example, the user may make a payment after applying promotion(s) stored on the user device from previous shopping(s). At block 480b, the user may receive the electronic receipt after the payment is finished. When the bill is paid through the mobile transaction system, the user may receive the electronic receipt in the APP. At block 490b, the user may receive a promotion code from the server.

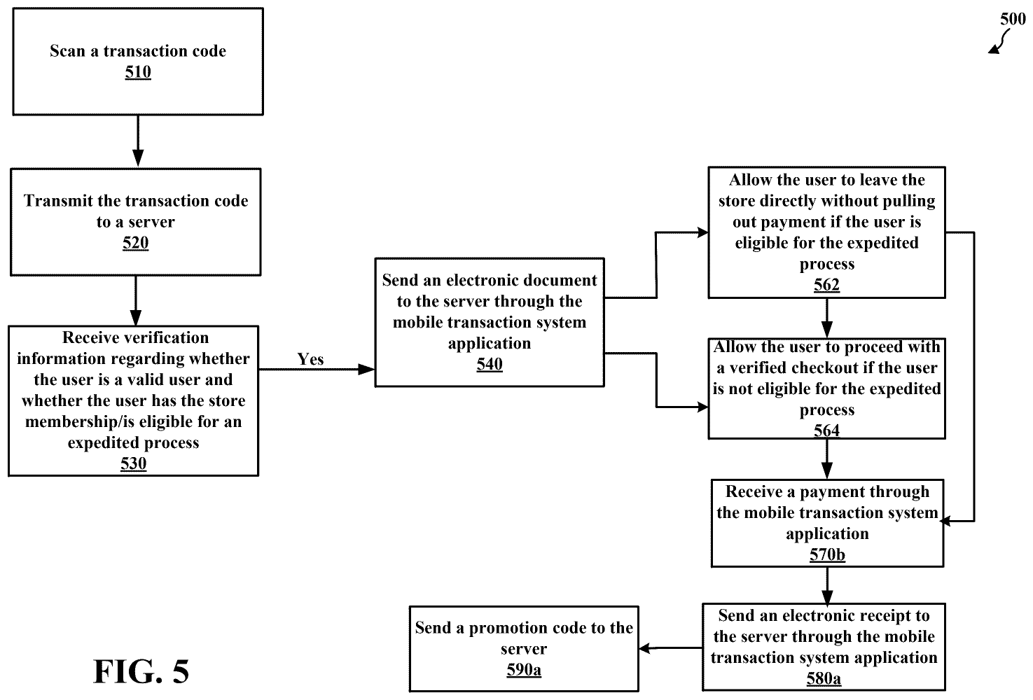

FIG. 5 is a flow diagram 500 of an example of the transaction procedure of the mobile transaction system from a client device's perspective according to one embodiment. Referring to FIG. 5, at block 510, the client device 120 of the store may scan the transaction code displayed on the user device 130 using the scanner of the client device. The transaction code may be scanned by a store cashier. When a user shows the transaction code at the checkout, the store cashier may scan the transaction code. At block 520, the client device 120 may transmit the transaction code to the server, in order to get the user verified by the server.

At block 530, the client device 120 may receive verification information regarding whether the user is a valid user and whether the user is a member of a user group associated with the client (e.g., store membership group). This verification checks whether the user is a valid user of the mobile transaction system and whether the user has membership of the client (e.g., store). In some examples, the client device 120 may receive verification information regarding whether the user is eligible for an expedited process for the transaction (e.g., an expedited checkout).

At block 540, the client device 120 may send an electronic document (e.g., an electronic bill) for the current purchase to the server through the APP immediately after all shopping items are scanned. The electronic document includes information describing one or more activities of the transaction (e.g., one or more shopping items). The server may transmit the electronic document to the user device 130. The store cashier may scan the items and the store may send an electronic bill to the server automatically. The server may push the bill to the user's app.

At block 562, after items are scanned, if the user meets the requirements for the expedited checkout, the user may be allowed to leave the store directly without pulling out the payment methods, or waiting for the payment to be processed. The cashier may let the user go, and move on to serve the next user in line.

At block 564, after items are scanned, if the user does not meet the requirements for the expedited checkout or the user chooses not to use the expedited checkout, the user may proceed with a verified checkout (e.g., the user may pay for the bill immediately at the checkout counter after the bill is received through the APP, the store receives payment information from the server of the mobile transaction system, and proceeds with the payment transaction). The cashier may wait for the user to make payment for the bill through the APP, and transaction confirmation from the store.

At block 570b, the client device may receive a consideration (e.g., payment) through the mobile transaction system application. For example, the client device may receive the payment after the user has applied promotion(s) stored on the user device from previous shopping(s). At block 580a, the client device 120 may generate an electronic receipt after the payment is received and send the electronic receipt to the server. When the bill is paid off at the client (e.g., store) or later through the APP, the client device may generate a receipt, and send it to the server.

At block 590a, the client device 120 may generate a promotion code based on a shopping trend of user and send the promotion code to the server. The server may forward the promotion code to the user device.

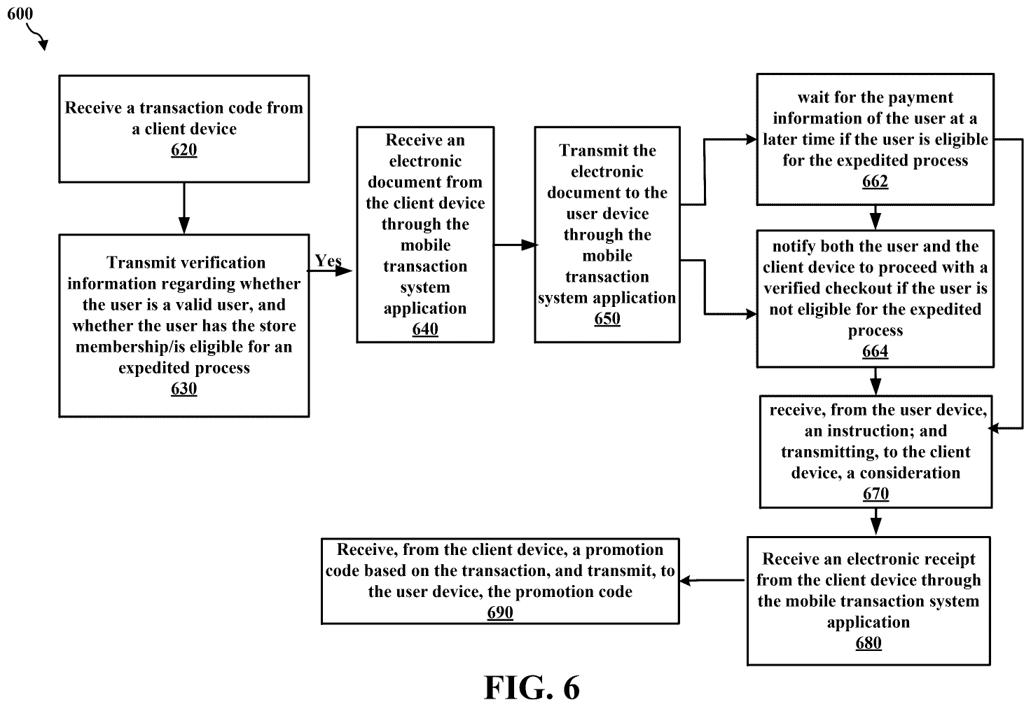

FIG. 6 is a flow diagram of an example 600 of the transaction procedure of the mobile transaction system from a server's perspective according to one embodiment. Referring to FIG. 6, at block 620, the server 110 of the mobile transaction system receives a transaction code from a client device. The server verifies the user account and if the user has the store membership. At block 630, the server 110 transmits, to the client device, verification information regarding whether the user is a valid user of the mobile transaction system and whether the user is a member of a user group associated with the client (e.g., store membership group). In some examples, the server may further identify if the user is eligible for an expedited process (e.g., expedited checkout). The server may further transmit, to the client device, verification information regarding whether the user is eligible for the expedited process for the transaction.

The server may send this verification information to the store.

At block 640, the server 110 may receive, from the client device, an electronic document (e.g., an electronic bill) of the current purchase through the APP immediately after all shopping items are scanned. The electronic document includes information describing one or more activities of the transaction (e.g., one or more shopping items). At block 650, the server 110 may transmit the electronic document to the user device 130. The store cashier may scan the items and the client device may send an electronic bill to the server automatically. The server may push the bill to the user's app.

At block 662, if the user is eligible for the expedited process (e.g., expedited checkout), the server 110 may wait for the user to review the electronic document through the APP, and the server 110 may wait for the payment information of the user, including available promotion/coupons, and payment (credit card, debit card) selection, with a predetermined time period. The predetermined time period may be 1, 2, 3, 5, 10, 20, or 30 days. The user may be allowed to leave the store directly without pulling out the payment methods, or waiting for the payment to be processed. The cashier may let the user go, and move on to serve the next user in line.

At block 664, if the user is not eligible for the expedited process (e.g., expedited checkout), the server 110 may notify both the user and the client device to proceed with a verified checkout, e.g., choosing a valid payment to finish the transaction at the store before leaving.

At block 670, as an example, the server may receive, from the user device, an instruction to commit to the transaction after the point in time within a predefined time period, in response to determining that the user is eligible for the expedited process; and in response to the instruction, the server may transmit, to an account associated with the client device, a consideration received from an account associated with the user. As another example, the server may receive, from the user device, an instruction to commit to the transaction at the point in time, in response to determining that the user is not eligible for the expedited process; and in response to the instruction, the server may transmit, to an account associated with the client device, a consideration received from an account associated with the user. The server may receive the user's payment information, the server may forward the payment information to the facility associated with the client device, e.g., the store's checkout system.

At block 680, the server 110 may receive, from the client device, an electronic receipt after the payment is received. When the bill is paid off at the store or later through the APP, the server may receive the receipt from the client device. The server 110 may transmit the electronic receipt to the user device. The server then pushes it to the user's APP.

At block 690, the server may receive, from the client device, a promotion code based on a shopping trend of user. The server may forward the promotion code to the user device.

By using the mobile transaction system, the users may have a fast checkout and better shopping experience based on multiple functionalities of the mobile transaction system. The mobile transaction system has the following unique features: combining payment procedure and store membership verification into one operation verification; converting in-person shopping (shop-in-store, pay-in-store) into two stages, shop-in-store first, pay-online later; and managing memberships, electronic receipts, and promotions, from multiple stores in a single APP. The multiple functionalities of the mobile transaction system improves computer technologies in the field of processing transactions. Since the memberships, electronic receipts, and promotions, from multiple stores are managed in a single APP, the computing resources for such management is reduced.

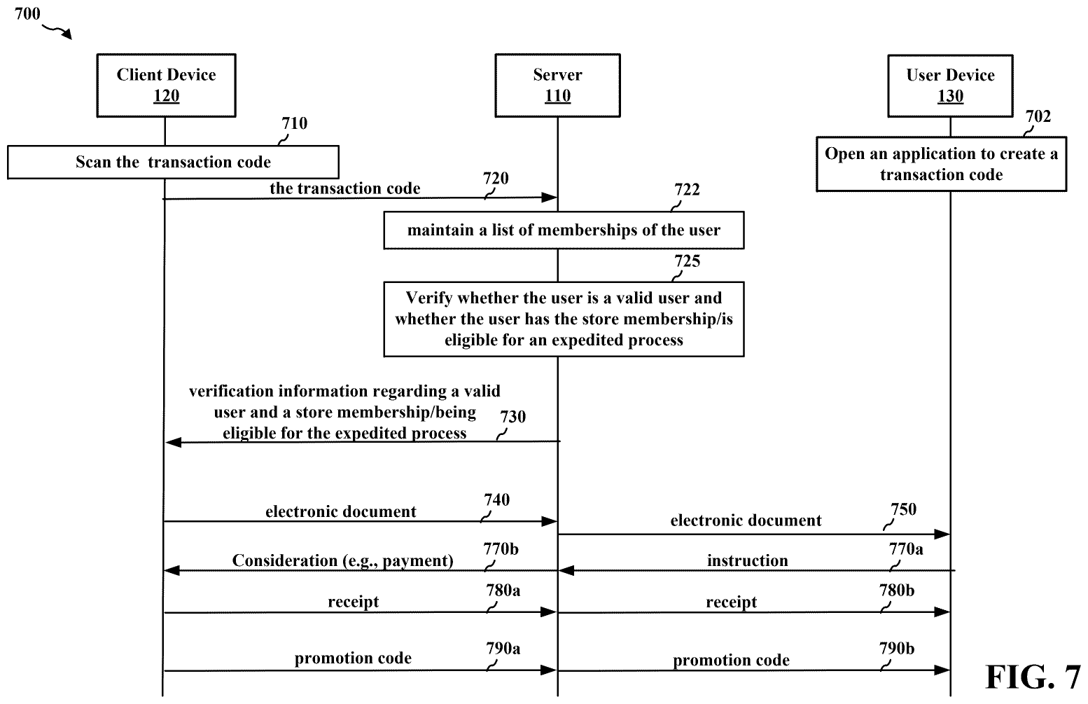

FIG. 7 is a flow diagram of an example of processing a transaction by a mobile transaction system according to one embodiment. Referring to FIG. 7, the user may open 702 the application of the mobile transaction system on a user device 130 to create a transaction code (e.g., a payment code) associate with the transaction. The transaction code uniquely identifies the transaction between the client device 120 and the user device 130 occurred at a point in time. The transaction code is created per transaction, with short live time, e.g., 10 seconds, 30 second, 1 minute, 2 minutes, 5 minutes, for security purpose. The transaction code does not require internet connection to the server of the mobile transaction system. At any time of the shopping items scanning process, the user may unlock the mobile transaction system application (APP) to create the transaction code. The client device 120 of the store may scan 710 the transaction code displayed at the user device 130 by using a scanner of the client device. The transaction code may be scanned by a store cashier.

The server 110 of the mobile transaction system receives 720 the transaction code from the client device 120. In some examples, the server 110 may maintain 722 a list of a plurality of memberships of the user corresponding to a plurality of user groups associated with a plurality of client devices. The server 110 may be connected to the plurality of client devices and maintain the memberships of the plurality of client devices. The plurality of memberships includes a membership corresponding to the user group associated with the client device 120.

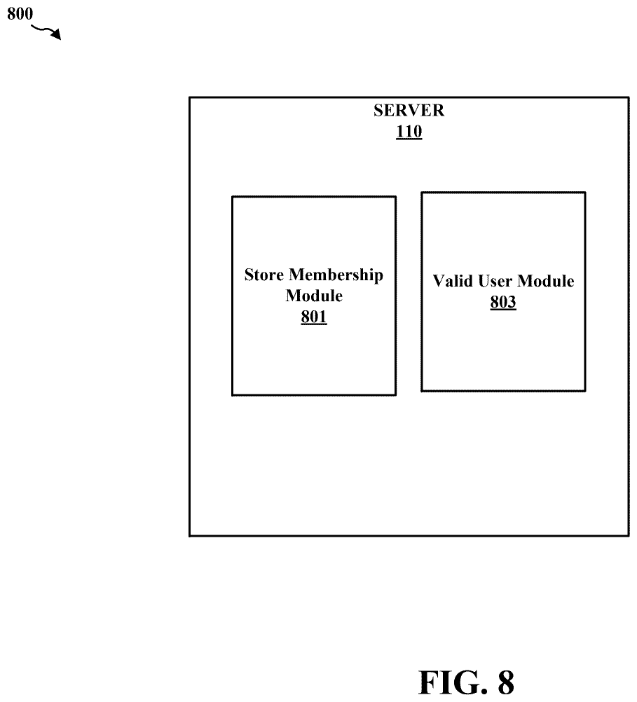

The server 110 verifies 725 the user account and if the user has the store membership. This verification checks whether the user is a valid user of the mobile transaction system and whether the user has membership of the store. As an example, the server 110 may verify whether the user is a member of the user group associated with the client based on the list. Referring to FIG. 8, the server 110 may include a store membership module 801, which stores the list of the plurality of memberships of the user corresponding to the plurality of user groups associated with the plurality of client. The server 110 may also include a valid user module 803, which stores a list of valid users who have a valid account of the mobile transaction system. The list of the plurality of memberships of the user corresponding to the plurality of user groups associated with the plurality of clients and/or the list of valid users may be stored in a database associated with the server. In some examples, the server 110 may further verify 725 if the user is eligible for an expedited process (e.g., checkout).

The server transmits 730, to the client device, verification information including whether the user is a valid user of the mobile transaction system and whether the user is a member of a user group associated with the client (e.g., store membership group). The verification information may further include whether the user is eligible for the expedited process for the transaction. The server may send this verification information to the store. During the expedited process, the user leaves the store without offering a consideration (e.g., payment) associated with the electronic document. Whether the user is eligible for the expedited process may be based on a transaction history of the user and the one or more activities of the electronic document. The transaction history may be maintained at the server and stored in the database. As an example, whether the user is eligible for the expedited process is based on an amount of incomplete transactions of the user or an amount of unfulfilled consideration of the user is less than a first predetermined threshold and an amount of the one or more activities listed in the electronic document is less than a second predetermined threshold. Qualifications for the expedited checkout may include both (1) the user has less than N (e.g., 1, 2, 3, 5, 10, or any numbers therebetween) unpaid bills or the amount of total unpaid bills is less than X (e.g., $10, $50, $100, $200, $500, or any numbers therebetween), and (2) the amount of the transaction is less than Y (e.g., $10, $50, $100, $200, $500, or any numbers therebetween). The expedited checkout may create a time gap between “provided services/goods” and “paid in full”. Expedited checkout may possibly incur unpaid bills to the store due to a failure to process the user's default payment method.

The server 110 may receive 740, from the client device 120, an electronic document (e.g., an electronic bill) of the current purchase through the APP immediately after all shopping items are scanned. The electronic document includes information describing one or more activities of the transaction (e.g., one or more shopping items). The store cashier may scan the items and the client (e.g., store) may send 740 the electronic bill to the server automatically.

The server 110 may transmit 750 the electronic document to the user device 130. The server may push 750 the bill to the APP on the user device.

If the user is eligible for the expedited process (e.g., expedited checkout), the server may wait for the payment information of the user including available promotion/coupons, and payment(credit card, debit card) selection, within a predetermined time period. The user may be allowed to leave the store directly without pulling out the payment methods, or waiting for the payment to be processed. The cashier may let the user go, and move on to serve the next user in line. If the user is not eligible for the expedited process (e.g., expedited checkout), the server may notify both the user and the client device to proceed with a verified checkout, e.g., choosing a valid payment to finish the transaction at the store before leaving.

As an example, in response to determining that the user is eligible for the expedited process (expedited checkout), the server 110 may receive 770a, from the user device 130, an instruction to commit to the transaction within a predefined time period after the point in time, after the user device receiving the electronic document. In response to the instruction, the server 110 may transmit 770b, to an account associated with the client device, a consideration received from an account associated with the user. The user may offer the consideration (e.g., make the payment) at a later time after leaving the store.

As another example, in response to determining that the user is not eligible for the expedited transaction, the server 110 may receive 770a, from the user device, an instruction to commit to the transaction at the point in time, after the user device receiving the electronic document; and in response to the instruction, the server may transmit 770b, to the account associated with the client device, the consideration received from the account associated with the user. The server may receive 770a the user's payment information, the server may send 770b the payment information to the facility associated the client device, e.g., the store's checkout system.

The user may apply related promotions (coupons) to the consideration (e.g., payment) by accessing a promotion module of the user device. The promotion module may store a list of promotions from multiple clients (e.g., stores). The user may apply the related promotions (coupons), e.g., a first promotion code, to modify the consideration and offer a modified consideration (e.g., making a modified payment). In one embodiment, the instruction may further comprise the first promotion code. The first promotion code may be selected from one or more promotion codes stored in the user device. The user may modify the consideration based on the first promotion code. The server 110 may transmit, to the account associated with the client device, the modified consideration received from the account associated with the user.

The server 110 may receive 780a, from the client device 120, an electronic receipt after the payment is received. When the bill is paid off at the store or later through the APP, the server may receive 780a the receipt from the client device. The server then may transmit 780b the electronic receipt to the user device 130.

The server 110 may receive 790a, from the client device 120, a promotion code (coupon) based on a shopping trend of user. The server 110 may forward 790b the promotion code to the user device 130. The user may apply the promotion code for a later purchase.

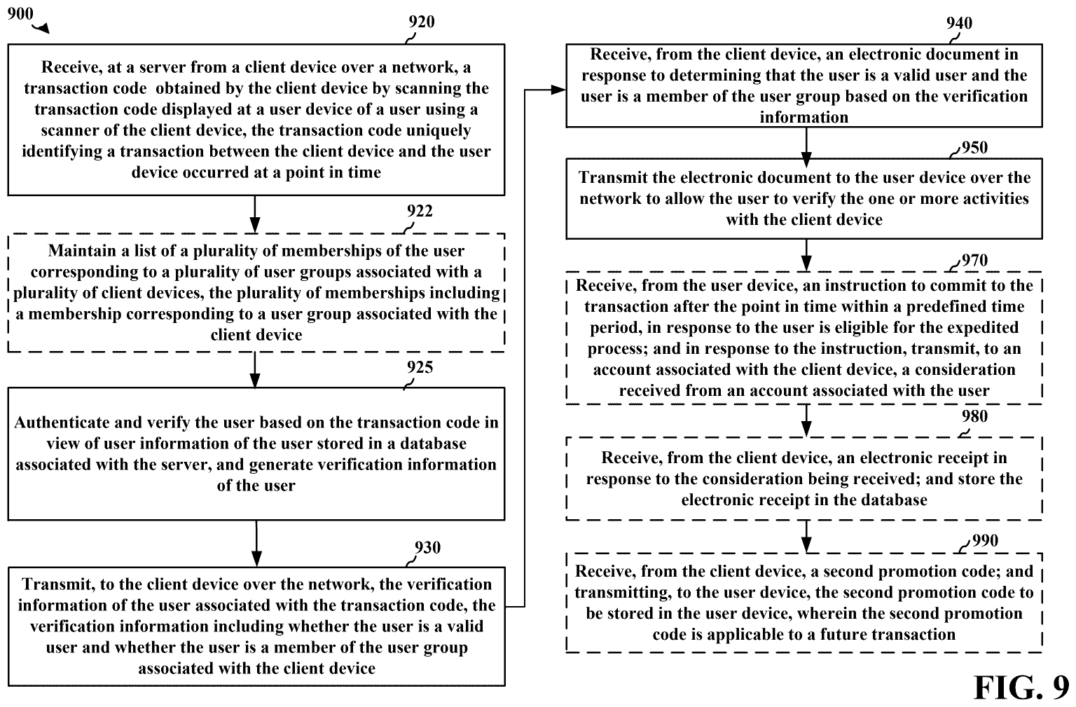

FIG. 9 is a flowchart of a process 900 of processing transaction data according to one embodiment. In some examples, the process 900 is performed, at least in part, by processing logic comprising hardware (e.g., circuitry, dedicated logic, etc.), software (e.g., software running on a chip, software run on a general-purpose computer system or a dedicated machine, etc.), firmware, or a combination of the three. In one embodiment, the process 900 is performed by a server, or at least one processor of the server, of a mobile transaction system.

Referring to FIG. 9, in operation 920, processing logic receives, from a client device over a network, a transaction code obtained by the client device by scanning the transaction code displayed at a user device of a user using a scanner of the client device. The transaction code uniquely identifies a transaction between the client device and the user device occurred at a point in time. In one embodiments, the transaction code is created by the user device in response to an input from the user at the user device when the user initiates the transaction, wherein the transaction code is generated without having the user device to contact the server.

In operation 922, processing logic maintains a list of a plurality of memberships of the user corresponding to a plurality of user groups associated with a plurality of client devices. The plurality of memberships includes a membership corresponding to the user group associated with the client device.

In operation 925, processing logic authenticates and verifies the user based on the transaction code in view of user information of the user stored in a database associated with the server, and generating verification information of the user. In one embodiment, processing logic verifies whether the user is the member of the user group associated with the client based on the list of the plurality of memberships of the user.

In operation 930, processing logic transmits, to the client device over the network, the verification information of the user associated with the transaction code. The verification information includes whether the user is a valid user of a mobile transaction system and whether the user is a member of a user group associated with the client.

In one embodiment, the verification information may further include whether the user is eligible for an expedited process. During the expedited process, the user leaves a facility associated with client without offering a consideration for the one or more activities of the transaction. In one embodiment, processing logic may further verify whether the user is eligible for the expedited process based on a transaction history of the user and the one or more activities of the electronic document, wherein the transaction history is maintained at the server and stored in the database. In one embodiment, processing logic may further verify whether the user is eligible for the expedited process based on an amount of incomplete transactions of the user or an amount of unfulfilled consideration of the user is less than a first predetermined threshold and an amount of the one or more activities listed in the electronic document is less than a second predetermined threshold.

In operation 940, processing logic receives, from the client device over the network, an electronic document in response to determining that the user is a valid user and the user is the member of the user group based on the verification information. The electronic document includes information describing one or more activities of the transaction.

In operation 950, processing logic transmits, to the user device over the network, the electronic document to allow the user to verify the one or more activities with the client device.

In operation 970, processing logic may receive, from the user device, an instruction to commit to the transaction after the point in time within a predefined time period, in response to determining that the user is eligible for the expedited process. In response to the instruction, processing logic may transmit, to an account associated with the client device, a consideration received from an account associated with the user. In one embodiment, the instruction may further comprise a first promotion code. The first promotion code is selected from one or more promotion codes stored in the user device. Processing logic may modify the consideration based on the first promotion code. Processing logic may transmit, to the account associated with the client device, a modified consideration received from the account associated with the user.

In operation 980, processing logic may receive, from the client device, an electronic receipt in response to the consideration being received; and store the electronic receipt in the database.

In operation 990, processing logic may receive, from the client device, a second promotion code; and transmit, to the user device, the second promotion code to be stored in the user device, wherein the second promotion code is applicable to a future transaction.

By using the mobile transaction system, the users may have a fast checkout and better shopping experience based on multiple functionalities of the mobile transaction system. The mobile transaction system has the following unique features: combining payment procedure and store membership verification into one operation verification; converting in-person shopping (shop-in-store, pay-in-store) into two stages, shop-in-store first, pay-online later; and managing memberships, electronic receipts, and promotions, from multiple stores in a single APP. The multiple functionalities of the mobile transaction system improve computer technologies in the field of processing transactions. Since the memberships, electronic receipts, and promotions, from multiple stores are managed in a single APP, the computing resources for such management are reduced. In this way, the amount of networking resources needed to manage the memberships, electronic receipts, and promotions, from multiple stores is reduced.

In some examples, the mobile transaction system may include a set of technologies which may be integrated to securely accept the considerations (e.g., payments) online. As an example, the payment information of the user may be converted to a single use token. The single-use token may be safely passed to the client device. The client device may process the transaction without ever handling, or storing sensitive payment information of the user. As another example, the server may store a plurality of valid secret keys associated with a plurality of client devices. The plurality of valid secret keys includes a secret key associated with the client device. The server may send the token and the secret key to the client device to conduct the transaction. The client device may prevent authorization of the transaction if the secret key is not a valid secret key, or if the secret key is not associated with the client device that is associated with the single use token.

In this disclosure, a user may refer to an individual who uses an application of the mobile transaction system in his/her smartphone. A client or a store may refer to any store where a transaction happens, for example, a department store (e.g., Target, CVS, Safeway) where in-person transaction happens, a store of a fast-food chain, a coffee shop, a restaurant, etc. An application may refer to an application of a mobile transaction system, e.g., an application of eClip, which is a mobile transaction system. A server may refer to a server of the mobile transaction system. An electronic document may refer to an itemized list of activities and an amount of money to be paid by the user to the store. A receipt may refer to a finalized itemized list and an amount of money (after membership, coupons, credit card benefits are applied) paid by the user to the store.

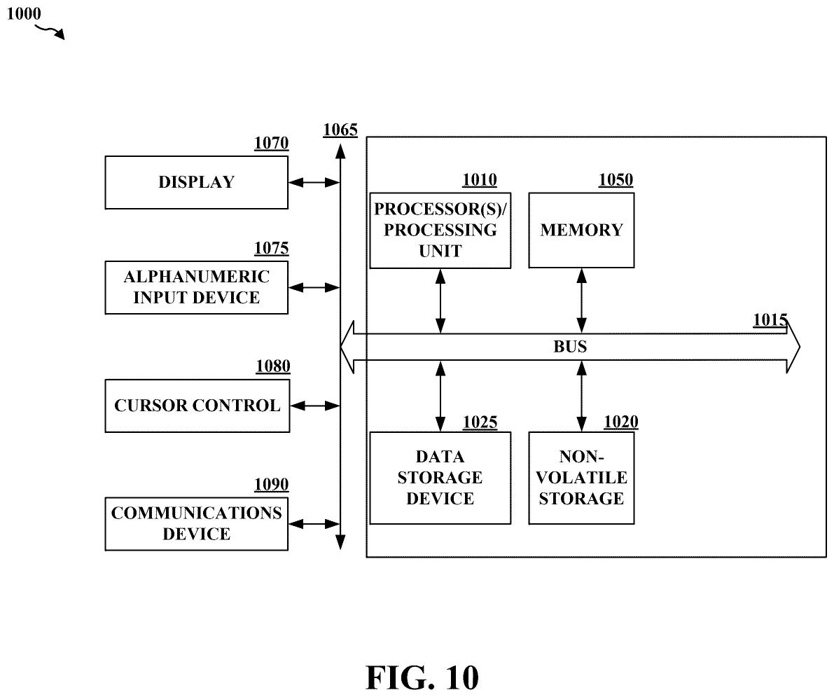

FIG. 10 is a block diagram of an example of a computer system that may be used to support the systems and operations discussed herein according to one embodiment. It will be apparent to those of ordinary skill in the art, however, that other alternative systems of various system architectures may also be used.

The data processing system illustrated in FIG. 10 includes a bus or other internal communication means 1015 for communicating information, and a processor(s) 1010 coupled to the bus 1015 for processing information. The system further comprises a random-access memory (RAM) or other volatile storage device 1050 (referred to as memory), coupled to bus 1015 for storing information and instructions to be executed by processor 1010. Main memory 1050 also may be used for storing temporary variables or other intermediate information during execution of instructions by processor(s) 1010. The system also comprises a read only memory (ROM) and/or static storage device 1020 coupled to bus 1015 for storing static information and instructions for processor 1010, and a data storage device 1025 such as a magnetic disk or optical disk and its corresponding disk drive. Data storage device 1025 is coupled to bus 1015 for storing information and instructions.

The system may further be coupled to a display device 1070, such as a light emitting diode (LED) display or a liquid crystal display (LCD) coupled to bus 1015 through bus 1065 for displaying information to a computer user. An alphanumeric input device 1075, including alphanumeric and other keys, may also be coupled to bus 1015 through bus 1065 for communicating information and command selections to processor 1010. An additional user input device is cursor control device 1080, such as a touchpad, mouse, a trackball, stylus, or cursor direction keys coupled to bus 1015 through bus 1065 for communicating direction information and command selections to processor 1010, and for controlling cursor movement on display device 1070.

Another device, which may optionally be coupled to computer system 1000, is a communication device 1090 for accessing other nodes of a distributed system via a network. The communication device 1090 may include any of a number of commercially available networking peripheral devices such as those used for coupling to an Ethernet, token ring, Internet, or wide area network. The communication device 1090 may further be a null-modem connection, or any other mechanism that provides connectivity between the computer system 1000 and the outside world. Note that any or all of the components of this system illustrated in FIG. 10 and associated hardware may be used in various embodiments as discussed herein.

In one embodiment, processor(s) 1010 executes instructions to perform any of the operations described above including, but not limited to, receiving, at the server computer system 1000 from a client device over a network, a transaction code obtained by the client device by scanning the transaction code displayed at a user device of a user using a scanner of the client device, the transaction code uniquely identifying a transaction between the client device and the user device occurred at a point in time; authenticating and verifying the user based on the transaction code in view of user information of the user stored in a database associated with the server, and generating verification information of the user; transmitting, to the client device over the network, the verification information of the user associated with the transaction code, the verification information including whether the user is a valid user of a mobile transaction system and whether the user is a member of a user group associated with the client; receiving, from the client device over the network, an electronic document in response to determining that the user is a valid user and the user is the member of the user group based on the verification information, wherein the electronic document includes information describing one or more activities of the transaction; and transmitting, to the user device over the network, the electronic document to allow the user to verify the one or more activities with the client device.

It will be appreciated by those of ordinary skill in the art that any configuration of the system may be used for various purposes according to the particular implementation. The control logic or software implementing the described embodiments can be stored in main memory 1050, mass storage device 1025, or other storage medium locally or remotely accessible to processor 1010.

It will be apparent to those of ordinary skill in the art that the system, method, and process described herein can be implemented as software stored in main memory 1050 or read only memory 1020 and executed by processor 1010. This control logic or software may also be resident on an article of manufacture comprising a computer readable medium having computer readable program code embodied therein and being readable by the mass storage device 1025 and for causing the processor 1010 to operate in accordance with the methods and teachings herein.

The embodiments discussed herein may also be embodied in a handheld or portable device containing a subset of the computer hardware components described above. For example, the handheld device may be configured to contain only the bus 1065, the processor 1010, and memory 1050 and/or 1025. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 1010, a data storage device 1025, a bus 1015, and memory 1050, and only rudimentary communications mechanisms, such as a small touchscreen that permits the user to communicate in a basic manner with the device. In general, the more special purpose the device is, the fewer of the elements need to be present for the device to function.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Whereas many alterations and modifications of the present disclosure will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the disclosure.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “detecting”, “determining”, “performing”, “sending”, “generating”, “searching”, “selecting”, “receiving”, “matching”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

What is claimed is:

1. A computer-implemented method of processing transaction data, the method comprising:
receiving, at a server from a client device over a network, a transaction code obtained by the client device by scanning the transaction code displayed on a user device of a user using a scanner of the client device, the transaction code uniquely identifying a transaction between the client device and the user device occurred at a point in time;
authenticating and verifying the user based on the transaction code in view of user information of the user stored in a database associated with the server, and generating verification information of the user;
transmitting, to the client device over the network, the verification information of the user associated with the transaction code, the verification information including whether the user is a valid user of a mobile transaction system and whether the user is a member of a user group associated with a client;
receiving, from the client device over the network, an electronic document in response to determining that the user is a valid user, and the user is the member of the user group based on the verification information, wherein the electronic document includes information describing one or more activities of the transaction; and
transmitting, to the user device over the network, the electronic document to allow the user to verify the one or more activities with the client device.

2. The method of claim 1, wherein the transaction code is created by the user device in response to an input from the user at the user device when the user initiates the transaction, wherein the transaction code is generated without having the user device to contact the server.

3. The method of claim 1, further comprising:
maintaining a list of a plurality of memberships of the user corresponding to a plurality of user groups associated with a plurality of clients, the plurality of memberships including a membership corresponding to the user group associated with the client; and
wherein the authenticating and verifying the user comprises:
verifying whether the user is the member of the user group associated with the client based on the list.

4. The method of claim 1, wherein the verification information further includes whether the user is eligible for an expedited process, and wherein during the expedited process, the user leaves a facility associated with the client without offering a consideration for the one or more activities of the transaction.

5. The method of claim 4, wherein the authenticating and verifying the user further comprises:
verifying whether the user is eligible for the expedited process based on a transaction history of the user and the one or more activities of the electronic document, wherein the transaction history is maintained at the server and stored in the database.

6. The method of claim 4, wherein the authenticating and verifying the user further comprises:
verifying whether the user is eligible for the expedited process based on an amount of incomplete transactions of the user or an amount of unfulfilled consideration of the user is less than a first predetermined threshold and an amount of the one or more activities listed in the electronic document is less than a second predetermined threshold.

7. The method of claim 4, further comprising:
receiving, from the user device, an instruction to commit to the transaction after the point in time within a predefined time period, in response to determining that the user is eligible for the expedited process; and
in response to the instruction, transmitting, to an account associated with the client, a consideration received from an account associated with the user.

8. The method of claim 7, further comprising:
receiving, from the client device, an electronic receipt in response to the consideration being received; and
storing the electronic receipt in the database.

9. The method of claim 7, wherein the instruction further comprises a first promotion code, wherein the first promotion code is selected from one or more promotion codes stored in the user device, the method further comprising:
modifying the consideration based on the first promotion code; and
wherein the transmitting, to an account associated with the client, a consideration received from an account associated with the user comprises:
transmitting, to the account associated with the client, a modified consideration received from the account associated with the user.

10. The method of claim 9, further comprising:
receiving, from the client device, a second promotion code; and
transmitting, to the user device, the second promotion code to be stored in the user device, wherein the second promotion code is applicable to a future transaction.

11. A mobile transaction system, comprising:
a processor; and
a memory coupled to the processor to store instructions, which when executed by the processor, cause the processor to perform:
receiving, from a client device over a network, a transaction code obtained by the client device by scanning the transaction code displayed at a user device of a user using a scanner of the client device, the transaction code uniquely identifying a transaction between the client device and the user device occurred at a point in time;
authenticating and verifying the user based on the transaction code in view of user information of the user stored in a database associated with the server, and generating verification information of the user;
transmitting, to the client device over the network, the verification information of the user associated with the transaction code, the verification information including whether the user is a valid user of a mobile transaction system and whether the user is a member of a user group associated with a client;
receiving, from the client device over the network, an electronic document in response to determining that the user is a valid user and the user is the member of the user group based on the verification information, wherein the electronic document includes information describing one or more activities of the transaction; and
transmitting, to the user device over the network, the electronic document to allow the user to verify the one or more activities with the client device.

12. The mobile transaction system of claim 11, wherein the processor is further caused to perform:
maintaining a list of a plurality of memberships of the user corresponding to a plurality of user groups associated with a plurality of clients, the plurality of memberships including a membership corresponding to the user group associated with the client; and
wherein the authenticating and verifying the user comprises:
verifying whether the user is the member of the user group associated with the client based on the list.

13. The mobile transaction system of claim 11, wherein the verification information further includes whether the transaction is eligible for an expedited process, and wherein during the expedited process, the user leaves a facility associated with the client without offering a consideration for the one or more activities of the transaction.

14. The mobile transaction system of claim 13, wherein the authenticating and verifying the user further comprises:
verifying whether the user is eligible for the expedited process based on an amount of incomplete transactions of the user or an amount of unfulfilled consideration of the user is less than a first predetermined threshold and an amount of the one or more activities listed in the electronic document is less than a second predetermined threshold.

15. The mobile transaction system of claim 13, wherein the processor is further caused to perform:
receiving, from the user device, an instruction to commit to the transaction after the point in time within a predefined time period, in response to determining that the transaction is eligible for the expedited process; and
in response to the instruction, transmitting, to an account associated with the client, a consideration received from an account associated with the user.

16. A non-transitory machine-readable medium having instructions stored therein, which when executed by a processor, cause the processor to perform:
receiving, from a client device over a network, a transaction code obtained by the client device by scanning the transaction code displayed on a user device of a user using a scanner of the client device, the transaction code uniquely identifying a transaction between the client device and the user device occurred at a point in time;
authenticating and verifying the user based on the transaction code in view of user information of the user stored in a database associated with the server, and generating verification information of the user;
transmitting, to the client device over the network, the verification information of the user associated with the transaction code, the verification information including whether the user is a valid user of a mobile transaction system and whether the user is a member of a user group associated with a client;
receiving, from the client device over the network, an electronic document in response to determining that the user is a valid user and the user is the member of the user group based on the verification information, wherein the electronic document includes information describing one or more activities of the transaction; and
transmitting, to the user device over the network, the electronic document to allow the user to verify the one or more activities with the client device.

17. The non-transitory machine-readable medium of claim 16, wherein the processor is further caused to perform:
maintaining a list of a plurality of memberships of the user corresponding to a plurality of user groups associated with a plurality of clients, the plurality of memberships including a membership corresponding to the user group associated with the client; and
wherein the authenticating and verifying the user comprises:
verifying whether the user is the member of the user group associated with the client based on the list.

18. The non-transitory machine-readable medium of claim 16, wherein the verification information further includes whether the transaction is eligible for an expedited process, and wherein during the expedited process, the user leaves a facility associated with client without offering a consideration for the one or more activities of the transaction.

19. The non-transitory machine-readable medium of claim 18, wherein the authenticating and verifying the user further comprises:
verifying whether the user is eligible for the expedited process based on an amount of incomplete transactions of the user or an amount of unfulfilled consideration of the user is less than a first predetermined threshold and an amount of the one or more activities listed in the electronic document is less than a second predetermined threshold.

20. The non-transitory machine-readable medium of claim 18, wherein the processor is further caused to perform:
receiving, from the user device, an instruction to commit to the transaction after the point in time within a predefined time period, in response to determining that the transaction is eligible for the expedited process; and
in response to the instruction, transmitting, to an account associated with the client, a consideration received from an account associated with the user.
